(19) United States
(12) Patent Application Publication
(10) Pub. No.: US 2013/0250177 A1
(43) Pub. Date: Sep. 26, 2013

(54) METHOD AND DEVICE FOR TENTATIVELY DISPLAYING PROJECTION IMAGE, SCREENING FILM, METHOD AND DEVICE FOR PRODUCING THE SAME, PROJECTION IMAGE PROJECTING METHOD, PROGRAM, AND MOVIE SYSTEM

(71) Applicant: FUJIFILM Corporation, Tokyo (JP)

(72) Inventor: Yasuharu IWAKI, Tokyo (JP)

(73) Assignee: FUJIFILM Corporation, Tokyo (JP)

(21) Appl. No.: 13/896,445

(22) Filed: May 17, 2013

Related U.S. Application Data
(63) Continuation of application No. PCT/JP2011/076540, filed on Nov. 17, 2011.

(30) Foreign Application Priority Data
Nov. 19, 2010 (JP) 2010-259399
Nov. 14, 2011 (JP) 2011-248303

(51) Int. Cl. H04N 9/31

(52) U.S. Cl. CPC H04N 9/3182
USPC 348/655

(57) ABSTRACT

Using a lookup table for obtaining a tentative-display image having colors that agree with colors of a projection image when a screening film, which is produced based on image data produced by measuring a shading pattern of a projector used to screen the screening film onto a screen and editing an input image, is projected onto the screen, color-correction image data for tentatively displaying the projection image are produced from image data, while image data are produced by providing color-correction image data with the shading pattern and, for verifying a showing of the projection image to be projected, the projection image is tentatively displayed as the tentative-display image based on the shading-provided image data.

### BACKGROUND OF THE INVENTION

The present invention relates to a method and device for tentatively displaying a projection image, a screening film, a method and a device for producing the same, a projection image projecting method, a program, and a movie system and, more particularly, to a method and device for tentatively displaying a projection image such as a method of digital projection and display on a monitor of a tentative-display projection image provided with a shading of a projector of a movie system, a screening film (film distributed for screening) having printed thereon a projection image provided with a corrected shading of a projector of a movie system, a method and a device for producing the same, a method and a device for projecting a projection image of said screening film, a program, and a movie system.

Conventionally, the process of producing a screening film (film distributed for screening) of a movie system or a positive projection print comprises acquiring digital image data obtained by reading a recorded, developed negative movie recording film with an image input device such as a telecine device and digitalizing the read data, digital image data recorded by a digital movie camera, and digital image data such as computer graphics (CG) image data produced by, for example, a computer, and performing digital image editing on the acquired digital image data, to acquire edited image data, i.e., image data of a projection image that is printed onto the screening film (see JP 2010-74759 A, JP 2010-55029 A, and JP 7-15658 A).

Thereafter, before the screening film is produced, the edited image data of the projection image are tentatively displayed (also referred to below as previewed) directly onto the screen by digital projection or tentatively displayed directly on, for example, a television or a monitor to verify the colors the projection image has when the screening film is projected by a projector.

When the colors of the projection image are judged appropriate upon verification, the image data of the edited projection image is exposed and developed by an exposure device onto a movie film to produce a negative movie film or an intermediate negative film (intermediate negative), and the intermediate negative is exposed and developed by the exposure device directly onto positive movie films thereby to produce a large number of screening films (positive projection prints).

When such images are allowed to undergo digital processing, image data are edited or exposed, or an edited image is previewed, among others, a three-dimensional lookup table (LUT) is used for color correction of image data in order to properly control the colors of image data (see JP 2010-74759 A and JP 2010-55029 A).

The three-dimensional LUT used for color correction is produced based on a result obtained by exposing an exposure pattern composed of different color patches. Because of the decrease in the three-dimensional LUT density reproduction accuracy due to, for example, the output device, the films used such as a negative movie film and a positive movie film, development process, measuring device, and measuring errors, the three-dimensional LUT for color-correction is corrected using a pattern of exposed patches of colors developed to a uniform density with a neutral gray density.

For digital processing of an image and for editing and exposure of image data, for example, use may be made of a three-dimensional LUT for color correction whereby the reproduced colors with which the projection image is to be presented on the screen when the projection image of a screening film is projected onto the screen agree with the colors intended when the movie was filmed, depending on, for example, the film, the output device, and the development process used.

Also for preview of an edited image, for example, use may be made of a preview LUT as a three-dimensional LUT for color correction that is produced such that a preview image digitally projected or displayed on a monitor is shown on the screen with reproduced colors that agree with the colors the projection image has when the projection image of the screening film is projected onto the projection screen.

### SUMMARY OF THE INVENTION

The three-dimensional LUT for color correction described in JP 2010-74759 A and JP 2010-55029 A enables the projection image of a screening film to have such reproduced colors, when the projection image is projected onto the projection screen, as agree with the colors of the projection image intended when the movie was filmed. Use of a preview LUT obtained from the three-dimensional LUT for color correction enables a preview image digitally projected onto the screen or displayed on a monitor to have reproduced colors that agree to a certain extent with the colors the projection image of the screening film has when the projection image is projected onto the projection screen.

However, when the projection image of a screening film is projected by a projector onto the screen, there arises a difference in showing between the projection image projected by the projector onto the screen, the preview image that is a projection image projected onto the screen by digital projection, and the preview image displayed on a monitor because the projection light of a projector has a shading whereby the amount of light decreases in the periphery of the screen as compared with the central region of the screen onto which the image is projected.

JP 7-15658 A describes a technique to correct the shading of the light source of a telecine device for converting a movie film to digital image data. However, correcting the shading of the light source cannot achieve correction of the difference in showing between the projection image projected onto the screen and the preview image.

The difference in showing between the projection image projected onto the screen and the tentative-display image displayed on the screen by digital projection or displayed on the monitor may be eliminated by optically correcting the shading itself of the light source of the projector at the projector or by using a light source without shading. Such approach, however, would require an expensive light source and complicate the configuration of the device, resulting in an expensive device.

An object of the present invention is to solve the problems in the prior art and provide, in the movie system, a method and a device for tentatively displaying a projection image, a screening film, a method and a device for producing the same, a projection image projecting method, a program, and a movie system wherein the showing with which the projection image is to be presented when the screening film is projected by a projector onto a screen can be made to agree or substantially agree with or be similar to the showing of a tentative-display (preview) image of the projection image without changing the configuration of the projector.

In order to achieve the above-mentioned object, according to the first aspect of the invention, there is provided a method of tentatively displaying a projection image for verifying a showing of the projection image when a screening film of a movie system is projected onto a screen before the screening film is projected onto the screen, the method comprising:

measuring a shading pattern of a projector used to project the projection image of the screening film onto the screen,

editing an input image to produce image data of the projection image,

producing image data of a color-correction tentative-display image for tentatively displaying the projection image from image data of the projection image using a lookup table for obtaining a tentative-display image having colors that agree with, approximate, or are similar to colors of the projection image when the screening film produced based on the image data of the produced projection image is projected onto the screen and producing image data of a shading-provided tentative-display image by providing image data of the color-correction tentative-display image with a shading pattern of the projector, and

tentatively displaying the projection image as the tentative-display image based on image data of the shading-provided tentative-display image in order to verify a showing of the projection image to be projected onto the screen using the projector.

Also, in order to achieve the above-mentioned object, according to the second aspect of the invention, there is provided a screening film production method for producing a screening film of a movie system including a projection image whose showing agrees with or is similar to a showing of the projection image verified with a tentative-display image of the projection image that is tentatively displayed before the screening film is projected onto a screen with a projector, the method comprising:

measuring a shading pattern of the projector used to project the projection image of the screening film onto the screen,

editing an input image to produce image data of the projection image,

producing exposure data of a projection image for producing the screening film from image data of the projection image by using a color-correction lookup table for obtaining the projection image when the screening film, having colors that agree with, approximate, or are similar to colors of the projection image tentatively displayed using image data of a tentative-display image produced based on the image data of the produced projection image, is projected onto the screen, and producing exposure data of a shading-provided projection image by providing the exposure data of the projection image with a shading pattern of the projector,

exposing and developing the projection image onto a movie film with the optical image exposure device using the exposure data of the shading-provided projection image to produce an intermediate film, and

exposing and developing the intermediate film onto the movie film to produce a screening film having printed thereon the projection image having the shading of the projector so corrected that the projection image has a same showing as the tentative-display image when the screening film is projected onto the screen by the projector.

Also, in order to achieve the above-mentioned object, according to the third aspect of the invention, there is provided a projection image projecting method, comprising screening the screening film produced by the screening film production method of the second aspect of the invention with the projector onto the screen to project the projection image having a same showing as the tentative-display image onto the screen.

Also, in order to achieve the above-mentioned object, according to the fourth aspect of the invention, there is provided a screening film that is projected onto a screen by a projector in a movie system, comprising a projection image having a corrected shading of the projector and having a same showing that agrees with or is similar to a showing of a tentative-display image of the projection image for verifying colors of the projection image produced from an input image by editing before the screening film is projected onto the screen.

Also, in order to achieve the above-mentioned object, according to the fifth aspect of the invention, there is provided a method of tentatively displaying a projection image for verifying a showing of the projection image when the projection image is projected onto a screen by a digital movie projector before the projection image is projected onto the screen, the method comprising:

measuring a shading pattern of the projector used to project a projection image corresponding to image data of an input image onto the screen,

producing image data of a color-correction tentative-display image for tentatively displaying the projection image from image data of the input image using a lookup table for obtaining a tentative-display image having colors that agree with, approximate, or are similar to colors of the projection image when the projection image corresponding to the image data of the input image is projected onto the screen and producing image data of a shading-provided tentative-display image by providing image data of the color-correction tentative-display image with a shading pattern of the projector, and

tentatively displaying the projection image as the tentative-display image based on the image data of the shading-provided tentative-display image in order to verify a showing of the projection image to be projected onto the screen using the projector.

Also, in order to achieve the above-mentioned object, according to the sixth aspect of the invention, there is provided a device for tentatively displaying a projection image for verifying a showing of a projection image when a screening film of a movie system is projected onto a screen before the screening film is projected onto the screen, the device comprising:

a measuring unit adapted to measure a shading pattern of a projector used to project the projection image of the screening film onto the screen,

a producing unit adapted to edit an input image to produce image data of the projection image,

a generating unit adapted to produce image data of a color-correction tentative-display image for tentatively displaying the projection image from image data of the projection image using a lookup table for obtaining a tentative-display image having colors that agree with, approximate, or are similar to colors of the projection image when the screening film produced based on the image data of the produced projection image is projected onto the screen and produce image data of a shading-provided tentative-display image by providing image data of the color-correction tentative-display image with a shading pattern of the projector, and

a display unit adapted to tentatively display the projection image as the tentative-display image based on image data of the shading-provided tentative-display image in order to verify a showing of the projection image to be projected onto the screen using the projector.

Also, in order to achieve the above-mentioned object, according to the seventh aspect of the invention, there is provided a screening film producing device for producing a screening film of a movie system including a projection image whose showing agrees with or is similar to a showing of the projection image verified with a tentative-display image of the projection image tentatively displayed before the screening film is projected onto a screen with a projector, the device comprising:

a measuring unit adapted to measure a shading pattern of the projector used to project the projection image of the screening film onto the screen,

a producing unit adapted to edit an input image to produce image data of the projection image,

a generating unit adapted to produce exposure data of a projection image for producing the screening film from image data of the projection image, using a color-correction lookup table for obtaining the projection image when the screening film, having colors that agree with, approximate, or are similar to colors of the projection image tentatively displayed using image data of a tentative-display image produced based on the image data of the produced projection image, is projected onto the screen, and produce exposure data of a shading-provided projection image by providing exposure data of the projection image with a shading pattern of the projector,

a first film producing unit adapted to expose and develop the projection image onto a movie film with the optical image exposure device using exposure data of the shading-provided projection image to produce an intermediate film, and

a second film producing unit adapted to expose and develop the intermediate film onto the movie film to produce a screening film having printed thereon the projection image having the shading of the projector so corrected that the projection image has a same showing as the tentative-display image when the screening film is projected onto the screen by the projector.

Also, in order to achieve the above-mentioned object, according to the eighth aspect of the invention, there is provided a device for tentatively displaying a projection image for verifying a showing of the projection image when the projection image is projected onto a screen by a digital movie projector before the projection image is projected onto the screen, the device comprising:

a measuring unit adapted to measure a shading pattern of the projector used to project a projection image corresponding to image data of an input image onto a screen,

a producing unit adapted to produce image data of a color-correction tentative-display image for tentatively displaying the projection image from image data of the input image using a lookup table for obtaining a tentative-display image having colors that agree with, approximate, or are similar to colors of the projection image when a projection image corresponding to the image data of the input image is projected onto the screen and produce image data of a shading-provided tentative-display image by providing image data of the color-correction tentative-display image with a shading pattern of the projector, and

a display unit adapted to tentatively display the projection image as the tentative-display image based on image data of the shading-provided tentative-display image in order to verify a showing of the projection image to be projected onto the screen using the projector.

Also, in order to achieve the above-mentioned object, according to the ninth aspect of the invention, there is provided a computer readable recording medium having recorded thereon a program adapted to cause a computer to execute steps for tentatively displaying a projection image for verifying a showing of the projection image when a screening film of a movie system is projected onto a screen before the screening film is projected onto the screen, wherein the program comprises:

a step of acquiring a shading pattern of a projector used to project the projection image of the screening film measured by a measuring unit onto the screen,

a step of editing an input image to produce image data of the projection image,

a step of producing image data of a color-correction tentative-display image for tentatively displaying the projection image from image data of the projection image using a lockup table for obtaining a tentative-display image having colors that agree with, approximate, or are similar to colors of the projection image when the screening film produced based on the image data of the produced projection image is projected onto the screen and producing image data of a shading-provided tentative-display image by providing image data of the color-correction tentative-display image with a shading pattern of the projector, and

a step of causing a display unit to tentatively display the projection image as the tentative-display image based on image data of the shading-provided tentative-display image in order to verify a showing of the projection image to be projected onto the screen using the projector.

Also, in order to achieve the above-mentioned object, according to the tenth aspect of the invention, there is provided a computer readable recording medium having recorded thereon a program adapted to cause a computer to execute steps of producing a screening film of a movie system including a projection image whose showing agrees with or is similar to a showing of the projection image verified with a tentative-display image of the projection image tentatively displayed before the screening film is projected onto a screen with a projector, wherein the program comprises:

a step of acquiring a shading pattern of the projector used to project the projection image of the screening film measured by a measuring unit onto the screen,

a step of editing an input image to produce image data of the projection image,

a step of generating exposure data of a projection image for producing the screening film from image data of the projection image using a color-correction lookup table for obtaining the projection image when the screening film, having colors that agree with, approximate, or are similar to colors of the projection image tentatively displayed using image data of a tentative-display image produced based on the image data of the produced projection image, is projected onto the screen, and produce exposure data of a shading-provided projection image by providing the exposure data of the projection image with a shading pattern of the projector,

a step of causing a first film producing unit to expose and develop the projection image onto a movie film with the optical image exposure device using the exposure data of the shading-provided projection image to produce an intermediate film, and

a step of causing a second film producing unit to expose and develop the intermediate film onto the movie film to produce a screening film having printed thereon the projection image having the shading of the projector so corrected that the projection image has a same showing as the tentative-display image when the screening film is projected onto the screen by the projector.

Also, in order to achieve the above-mentioned object, according to the eleventh aspect of the invention, there is provided a computer readable recording medium having recorded thereon a program adapted to cause a computer to execute steps for tentatively displaying a projection image for verifying a showing of the projection image when the projection image is projected onto a screen by a digital movie projector before the projection image is projected onto the screen, wherein the program comprises:

a step of acquiring a shading pattern of the projector used to project a projection image corresponding to image data of an input image measured by a measuring unit onto the screen,

a step of producing image data of a color-correction tentative-display image for tentatively displaying the projection image from image data of the input image using a lockup table for obtaining a tentative-display image having colors that agree with, approximate, or are similar to colors of the projection image when a projection image corresponding to the image data of the input image is projected onto the screen and produce image data of a shading-provided tentative-display image by providing image data of the color-correction tentative-display image with a shading pattern of the projector, and

a step of causing a display unit to tentatively display the projection image as the tentative-display image based on the image data of the shading-provided tentative-display image in order to verify a showing of the projection image to be projected onto the screen using the projector.

Also, in order to achieve the above-mentioned object, according to the eleventh aspect of the invention, there is provided a movie system, comprising:

a screen;

a projector adapted to project a projection image of a screening film onto the screen; and

a device for tentatively displaying a projection image described above.

Also, in order to achieve the above-mentioned object, according to the eleventh aspect of the invention, there is provided a movie system, comprising:

a screen;

a projector adapted to project a projection image of a screening film onto the screen; and

a screening film producing device described above.

According to the respective aspects of the invention, with the above configuration, the showing with which a projection image is presented on a screen when a screening film is projected by a projector onto the screen can be made to agree or substantially agree with or be similar to the showing of a tentative-display (preview) image of the projection image without changing the configuration of the projector in a movie system.

According to the first, second, sixth, seventh, ninth, tenth, twelfth, and thirteenth aspects of the invention, the showing of the preview image of a projection image can be made to agree or approximate the showing with which the projection image containing the shading of a projector is presented on the screen when a screening film is projected onto the screen by the projector. According to the fifth, eighth, and eleventh aspects of the invention, an input image can be verified with the colors and the shading with which the input image will be presented on a screen by a digital movie projector before an actual projection by the digital movie projector.

According to the third and fourth aspects of the invention, when a screening film is projected onto a screen by a projector, a projection image with a corrected shading of the projector can be projected onto a screen, and the showing thereof can be made to agree with or approximate the showing of the preview image of a projection image with no projector shading.

### BRIEF DESCRIPTION OF THE DRAWINGS

FIG. 1 is a block diagram illustrating an example of a configuration of a movie system adapted to implement a method of tentatively displaying a projection image, a method of producing a screening film, and a method of projecting a screening film according to the invention.

FIG. 2 is a conceptual diagram illustrating an example of a flow in which a method of tentatively displaying a projection image and a method of projecting a screening film according to the invention are implemented.

FIG. 3 is a schematic diagram illustrating an example of a film recording means shown in FIG. 1.

FIG. 4 is a schematic diagram illustrating an example of an optical printing means shown in FIG. 1.

FIG. 5 is a flow chart illustrating an example of a method of tentatively displaying a projection image according to the invention.

FIG. 6 is a flow chart illustrating an example of a method of evaluating, correcting, and using a tentative-display lookup table of the invention.

FIGS. 7A and 7B are conceptual diagrams respectively illustrating examples of a full-screen measuring position pattern image and measuring position pattern images simultaneously and parallelly projected onto a screen.

FIG. 8 is a block diagram illustrating an example of a configuration of a movie system adapted to implement a method of tentatively displaying a projection image according to the invention.

FIG. 9 is a flow chart illustrating a method of producing a color correction lookup table.

FIGS. 10A, 10B and 10C are schematic diagrams respectively representing a projection image, a projector shading pattern image, and a shading simulation image obtained by providing a projection image with a shading.

FIG. 11 is a conceptual diagram illustrating an example of a configuration of a processor adapted to provide image data with a shading pattern.

### DETAILED DESCRIPTION OF THE INVENTION

Detailed descriptions are made below of a method and a device for tentatively displaying a projection image, a screening film, a method and a device for producing a screening film, a method of projecting a projection image, a program, and a movie system with reference to preferred embodiments illustrated in attached drawings.

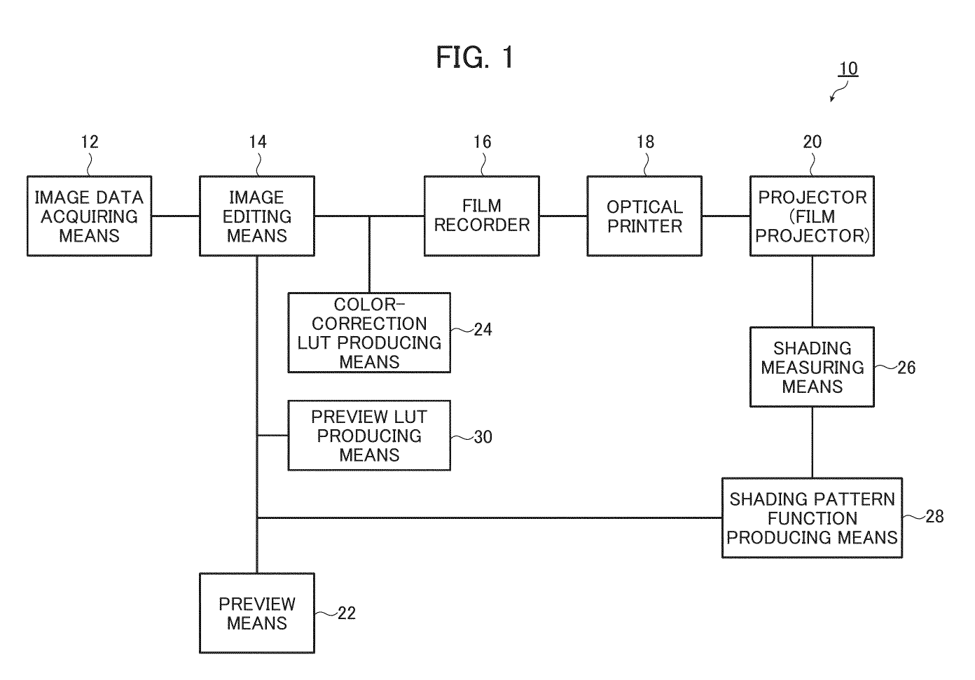

FIG. 1 is a block diagram illustrating an example of a configuration of a movie system adapted to implement a method of tentatively displaying a projection image, a method of producing a screening film, and a method of projecting a screening film according to the invention.

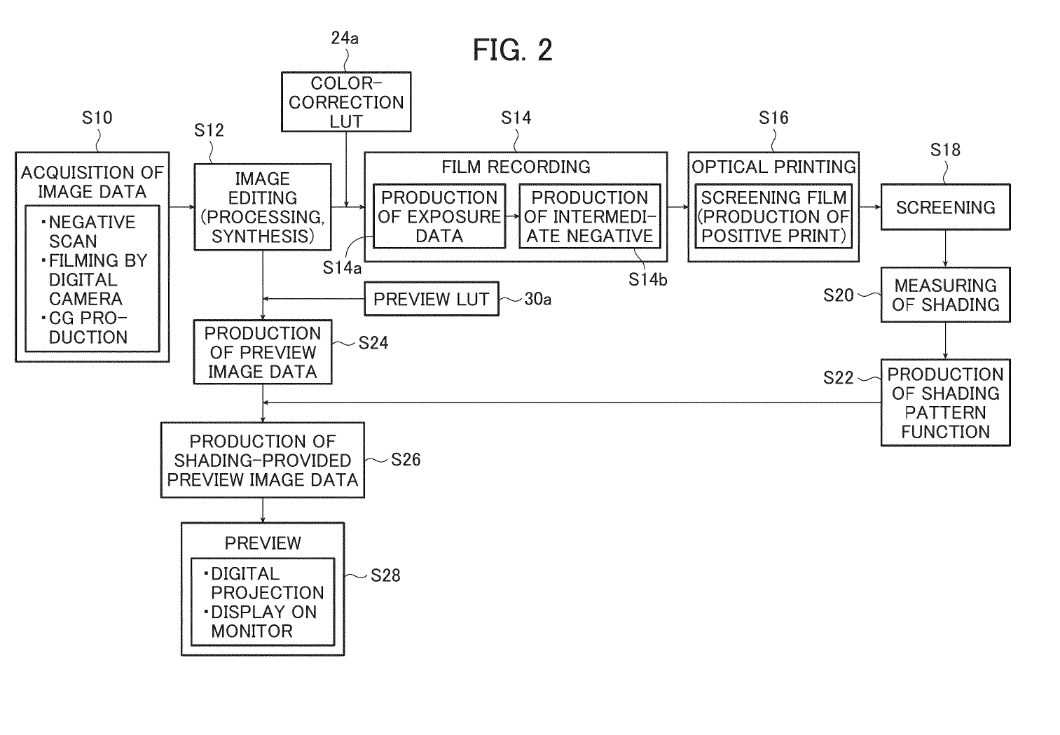

FIG. 2 is a conceptual diagram illustrating an example of a flow in which a method of tentatively displaying a projection image and a method of producing and projecting a screening film according to the invention are implemented by the movie system shown in FIG. 1.

As illustrated in FIG. 1, a movie system 10 comprises an image data acquiring means (also referred to simply as acquiring means below) 12, an image editing means (also referred to simply as editing means below) 14, a film recording means (also referred to as film recorder below) 16, an optical printing means (also referred to as optical printer below) 18, a projector (film projector) 20, a preview means 22, a color-correction LUT producing means (also referred to as first producing means below) 24, a shading measuring means (also referred to simply as measuring means below) 26, a shading pattern function producing means (also referred to simply as function producing means below) 28, and a preview LUT producing means (also referred to as second producing means below) 30.

The image data acquiring means 12 is an image data acquiring means exemplified by a scanner that performs negative scan to read digital image data from a recorded negative film, a digital camera that acquires digital image data of a shot image by shooting, and a computer that produces a computer graphics (CG) image to acquire digital image data.

The image editing means 14 performs, for example, editing, processing, and synthesis of image data acquired by the acquiring means 12 to produce image data of a projection image. The processes performed by the editing means 14 may be entrusted to, for example, a post-product company.

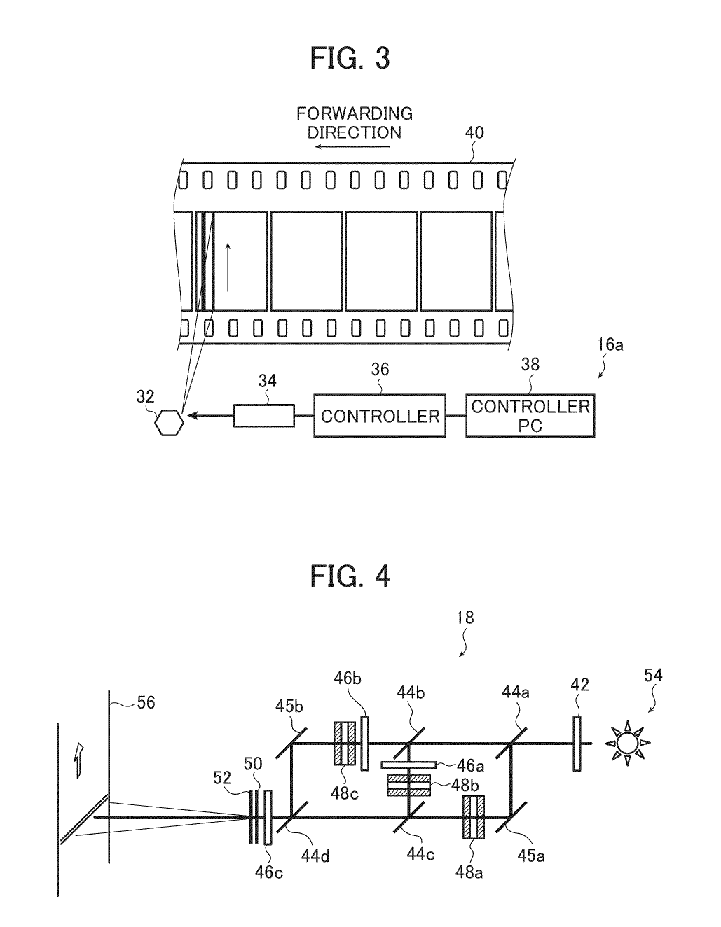

The film recorder 16 exposes image data edited by the editing means 14 to the digital recording film or the intermediate film using an optical image exposure device of scan exposure type employing laser light shown in FIG. 3 to produce a negative film (intermediate negative). Where necessary, a copied negative film may be produced from the negative film.

The film recorder 16 uses a developer to develop the negative film exposed by the optical image exposure device to produce an intermediate negative. The developer used by the film recorder 16 is not specifically limited and may be, for example, a cinema type developer FILM speed 100 ft/min manufactured by OTOMO Manufactory Co., Ltd. in this embodiment.

The optical printer 18 exposes the intermediate negative (negative film or a copied negative film) to a positive projection film using an optical exposure device of area exposure type illustrated in FIG. 4 and produces a screening film (positive film) for the projector 20 to project onto a screen.

The optical printer 18 develops the positive projection film area-exposed by the optical exposure device to produce a screening film. The developer used by the optical printer 18 is not specifically limited and may be, for example, a cinema type developer FILM speed 250 ft/min manufactured by OTOMO Manufactory Co., Ltd. in this embodiment.

The projector 20 projects the screening film produced by the optical printer 18 onto a projection screen thereby to project the projection image recorded on the screening film. As described later, the projector 20 comprises a shading in its projection light that is projected onto the screen.

The preview means 22 allows a projection image to be previewed (tentatively displayed) as a preview (tentative-display) image in order for pre-screening verification of the showing (including colors and brightness) with which the projection image is presented when the screening film is projected by the projector 20 onto the screen. The preview means 22 comprises a video converter (software or a hardware device) adapted to convert image data edited or otherwise processed by the image editing means 14 to image data of the preview (tentative-display) image and convert image data of the pixels of the converted preview image to shading-provided color-corrected preview image data and a video display device adapted to display the preview image using the color-corrected preview image data having undergone conversion by the video converter. The video display device may be, for example, a digital projector that projects the preview image directly onto the screen using digital image data of the projection image or a monitor that displays the preview image directly onto a monitor screen using digital image data of the projection image.

The first producing means (color-correction LUT producing means) 24 produces a three-dimensional color-correction LUT that is used to obtain exposure data of the projection image for exposing the image data of the projection image onto a negative movie film using the optical image exposure device of the film recorder 16 so that the colors of the projection image produced by the editing means 14 are reproduced in the projection image projected onto the screen by the projector 20.

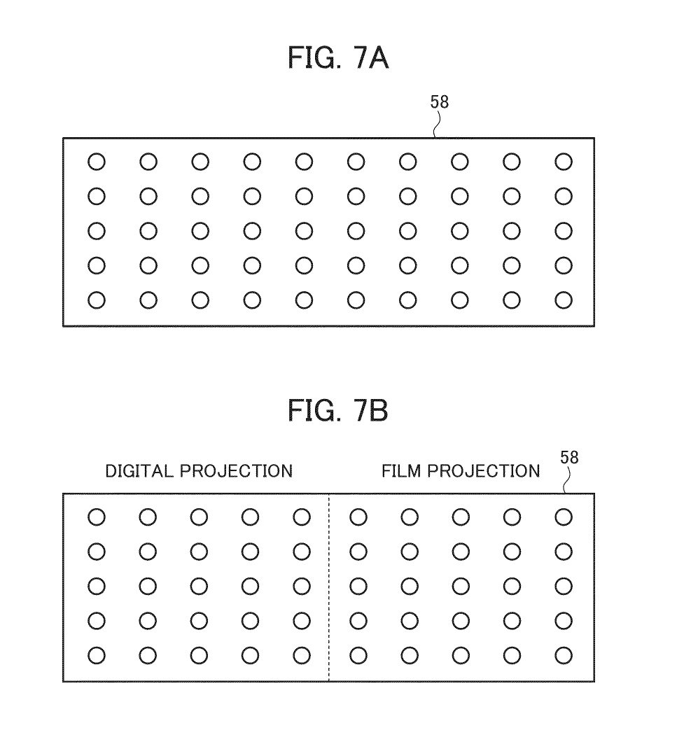

The shading measuring means 26 measures the shading pattern of projection light emitted by the projector 20 onto the screen and may be of a type that projects projection light of the projector 20 onto the screen, measures the amount of light (luminance) at measuring points in regions of the screen including a central region and a periphery with, for example, a luminance meter or a spectral luminance meter to obtain a light amount (luminance) distribution thereby to acquire a shading pattern or a light amount distribution function or of a type that projects a measuring chart film having a measuring position pattern image consisting of a plurality of measuring points onto the screen by the projector 20 (see FIG. 7) and measures luminance at the measuring points projected onto the screen with a telespectroscopic luminance meter to obtain a shading pattern.

The shading pattern function producing means 28 produces a shading pattern function by function approximation of a shading pattern measured by the measuring means 26, that is, by function approximation of measured values of luminance at the measuring points.

Based on, for example, the optical characteristics of the preview means 22 or the color-correction LUT produced by the first producing means, the second producing means (preview LUT producing means) 30 produces from the image data of the projection image a tentative-display (preview) LUT used to obtain image data of a tentative-display image that agrees with or is similar to the projection image provided with a shading given by the projector 20 in showing with which the projection image will be presented when the screening film, obtained using the exposure data of the projection image that is color-corrected using the color correction LUT, is projected onto the screen.

The negative movie film is a film, such as ETERNA500T produced by FUJIFILM Corporation, used for camera shooting; the digital recording film is a film, such as ETERNA-RDI produced by FUJIFILM Corporation, used exclusively for digital recording; and the intermediate film is a film such as ETERNA-CI produced by FUJIFILM Corporation, optimized for exposure by an exposure device of area exposure type. The positive screening film is a film, such as ETERNA Positive Film type 3513DI produced by FUJIFILM Corporation, optimized for exposure of a negative film by an exposure device of area exposure type. According to the invention, while various movie films are used in this embodiment, a variety of other films than mentioned above may be used.

Next, the flow in which a method of tentatively displaying the projection image and a method of producing and projecting the screening film according to the invention are implemented by the movie system 10 shown in FIG. 1 is described in detail with reference to FIG. 2.

First, the flow of the methods of producing and projecting the screening film is described.

As illustrated in FIG. 2, in Step S10, the recorded negative film is first scanned, read and digitized by the acquiring means 12 to obtain respective digital image data (signal values) of the frames of the recorded negative film. The respective densities of the obtained image data depend on the device characteristics of the acquiring means 12 used to read the recorded negative film.

In Step S10, digital image data of a shot image acquired with the acquiring means 12 such as a digital camera may be acquired, or digital image data may be acquired from a CG image produced by a computer.

Next, in Step S12, the respective signal values of the frames acquired in Step S10 are converted to printing density, which serves as reference for the respective images of the frames. In Step S12, after a showing of colors of the positive projection print produced based on the printing density is converted to a showing of colors of the screening film when the screening film is projected, the editing means 14 performs editing, processing, and synthesis of the image among other processes.

As described above, the printing density depends on the acquiring means 12 and also depends on the film characteristics of the recorded negative film. Therefore, before the editing, processing, and synthesis of the image in Step S12, the respective signal values of the frames acquired in Step S10 need to be converted to signal values corresponding in the showing of colors to those of the screening film when the screening film is projected.

In Step S12, because the printing density that depends on the acquiring means 12 and the negative film characteristics is converted to data corresponding to the processes such as editing, conversion of the image data is preferably implemented using, for example, a conversion LUT. Thus, the conversion LUT is used to convert the signal values obtained in Step S10 to standard data that do not depend on the acquiring means 12 or the film characteristics and which correspond to the showing of colors of the screening film when the screening film is projected.

In Step S12, the image data standardized with the conversion LUT undergo necessary processes such as editing, processing, and synthesis through the editing means 14 as described above. As described earlier, the image data to be edited in Step S12 are preferably corrected before editing so as to agree with the positive print in density. When image data adjusted to agree in density with the positive print as projected are dealt with, use may be made of the color correction LUT.

In Step S14, the image data edited and/or otherwise processed in Step S12 are sent to the film recorder 16 via the color-correction LUT 24a and, in Step S14a, converted to exposure data (control value) for the film recorder 16.

In Step S14, conversion by the color correction LUT 24a is implemented in order to convert the density of the image data edited and/or otherwise processed in Step S12 to exposure data, an output value corresponding to the film recorder 16. Thus, in Step S14a, the image data are converted to exposure data for the film recorder 16. The thus obtained exposure data of the projection image is adjusted so that the colors of the projection image as projected onto the screen coincide or agree with, or approximate the colors of an input image of which the image data are acquired by the image data acquiring means 12.

Next, based on the exposure data obtained through conversion by the color-correction LUT 24a in Step S14a, the digital recording film or the intermediate film is exposed by the film recorder 16 and, in step S14b, the negative film (intermediate negative) for producing a positive print is produced. While the recorded, developed negative film is used in Step S10 in this embodiment, the invention is not limited this way; use may be made of an image recorded on a digital recording film or an intermediate film.

Now, the exposure process performed in Step S14a by the film recorder 16 shown in FIG. 1 will be described below with reference to FIG. 3.

The negative film and the copied negative film are produced using an area exposure type optical exposure device such as an exposure means 16a of the film recorder 16 illustrated in FIG. 3.

In FIG. 3, the exposure means 16a comprises a spin mirror 32, a laser light source 34, a controller 36, and a personal computer for control (controller PC) 38. The controller PC 38 controls the controller 36 to control the operation of the laser light source 34. Laser light emitted from the laser light source 34 is reflected by the spin mirror 32 to irradiate a film 40 in a scan direction (upward in FIG. 3). The film 40 is moved in its forwarding direction (leftward in FIG. 3). The exposure means 16a thus implements optical exposure by scanning laser light over the film 40 two-dimensionally.

Upon completion of the negative film exposure process, development of the negative film is completed by the film recorder 16 in Step S14b, thereby producing the intermediate negative.

The movie system is often required to produce a large number of positive print films (screening films) for distribution to movie theaters in various parts of the country. It is therefore preferable to have copies of the intermediate negative used for production of the screening film ready for use.

Next, in step S16, the optical printer 18 is used to expose the negative film or a copied negative film thereof used to produce the positive film to a positive print film for screening using an area exposure type optical exposure device, and development is done using the developer of the optical printer 18 to complete the positive print for projection used for the screening film.

The screening film is thus produced.

Next, in Step S18, the screening film produced in Step S16 is projected onto the screen by the projector 20, and the projection image of the screening film is projected onto the screen.

Now, the exposure process performed by the optical printer 18 in Step S16 will be described below with reference to FIG. 4.

FIG. 4 schematically illustrates the optical printer 18 adapted to expose the exposed and developed negative film to the positive print film for projection. As illustrated in FIG. 4, the optical printer 18 comprises a heat-absorbing filter 42, dichroic mirrors 44a to 44d, mirrors 45a and 45b, ND filters 46a to 46c, slits 48a to 48c, a sharp cut filter 50, and a diffusion sheet 52.

White light 54 passes through the heat-absorbing filter 42, is split by the dichroic mirrors 44a and 44b into three components RGB, which pass through the ND filter 46b and the slit 48c, the ND filter 46a and the slit 48b, or the slit 48a, then combined by the dichroic mirror 44d to pass through the ND filter 46c and the sharp cut filter 50. Subsequently, the diffusion sheet 52 diffuses the light and sheds the light onto a movie film 56 so that the movie film 56 is thereby exposed evenly across its width, and a color-developed negative movie film is superposed on the positive movie film to be exposed so that the color-developed negative movie film is located on the side closer to the light source, whereupon exposure is implemented from the color-developed movie film side.

Thus, the optical printer 18 is so configured as to adjust the respective amounts of light R, G, and B independently.

The screening film producing method and the projection image projecting method are composed as described above.

Next, the method of measuring the shading of the projection light emitted by the projector and the method of tentatively displaying (previewing) the projection image are described.

As described earlier, the projection light emitted by the projector 20 has a shading such that the amount of the projection light is smaller in the periphery than in the central region of the screen onto which the projection light is projected.

In Step S20 that follows, the shading of the projection light emitted by the projector 20 is measured by the measuring means 26 on the screen to which the projection light is projected. Specifically, the amount (luminance, or preferably spectral luminance, and optical spectrum) of the projection light emitted by the projector 20 is measured at measuring points in regions of the screen to which the projection light is projected including the central region and the periphery with preferably a luminance meter, more preferably a spectral luminance meter, and most preferably a telespectroscopic luminance meter. Use of a telespectroscopic luminance meter to measure the amount of light (e.g., luminance) at measuring points requires viewing through the finder of the telespectroscopic luminance meter to determine the measuring positions. Therefore, accurate positioning to each of the measuring points takes about 1 to 2 seconds.

Because measuring the shading of the projection light of the projector 20 requires the measured values to be accurately correlated with the positions of the measuring points in the invention, it is preferable to produce a measuring chart film, which is a positive screening film having printed thereon a measuring position pattern image in which measuring points are located over the whole region of a screen 58 as illustrated in FIG. 7A, project the measuring chart film with the projector 20 onto the screen 58 so that the measuring position pattern image is projected onto the screen 58, and measure the amount (e.g., luminance) of the projection light with, for example, a luminance meter at the measuring points indicated in the projected measuring position pattern image.

Next, in Step S22, the shading pattern of the projection light of the projector 20 measured in Step S20 is function-approximated by the function producing means 28, whereby function approximation is achieved using the measured values of the amount of light (e.g., luminance) at the measuring points on the screen, to produce a shading pattern function.

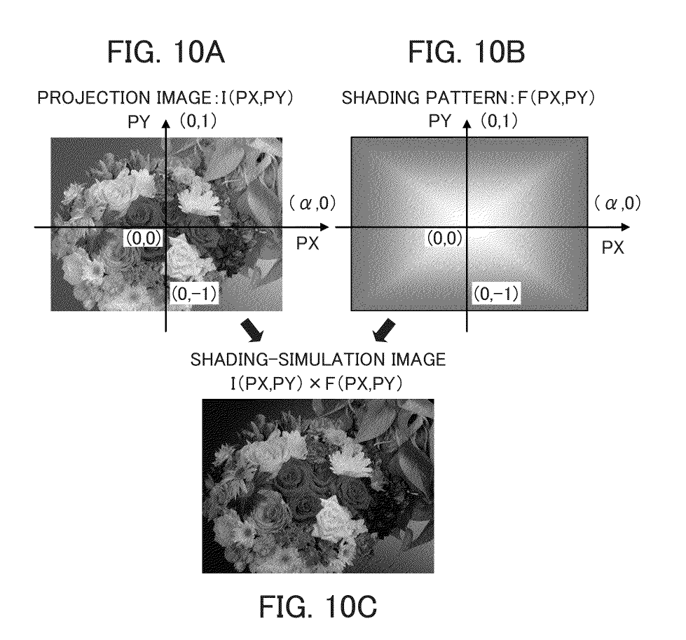

For example, the shading pattern illustrated in FIG. 10B can be approximated to a shading pattern function F(PX,PY) represented by the following equation (1):

F(PX,PY)=a×PX²+b×PY²+c×PX×PY+d×PX+e×PY+f (1)

where coefficients a to f have respective values as shown, for example, in Table 1.

In the coordinate system of the projection image and the shading pattern shown respectively in FIGS. 10A and 10B, the center of the projection image and the shading pattern is located at (0,0), and the length of the shorter side of the projection image is 2.

TABLE 1

| | For R | For G | For B |
|---|---|---|---|
| a = | −0.11959 | −0.119594 | −0.129522 |
| b = | −0.32244 | −0.322715 | −0.338413 |
| c = | 0.014383 | 0.0144385 | 0.0144649 |
| d = | −0.00309 | −0.003174 | −0.008739 |
| e = | −0.04722 | −0.047508 | −0.045542 |
| f = | 1 | 1 | 1 |

Measuring of the shading is thus completed.

Next, the flow of the process of the method of tentatively displaying the projection image is described.

As illustrated in FIG. 2, in Step S24, the image data edited and/or otherwise processed in Step S12 are sent through a preview LUT 30a to the preview means 22 and converted to image data of an image used for preview (tentative display) by the preview means 22.

The image data of the preview image thus obtained are color-adjusted so that the colors of the projection image previewed (tentatively displayed) coincide or agree with, or approximate the colors of the projection image projected onto the screen.

Next, in Step S26, the image data of the pixels of the preview image having undergone conversion through the preview LUT 30a in Step S24 are multiplied by a coefficient value F(PX,PY) obtained according to the pixel position from the shading pattern function of the projection light emitted by the projector 20 produced by the function producing means 28 in Step S22 to obtain color-corrected preview image data provided with shading.

The thus obtained color-corrected preview image data provided with shading has a shading that is so corrected that the showing (showing including colors and luminosity (brightness)) of the previewed projection image coincides (agrees) with, substantially agrees with, or approximates the showing of the projection image projected onto the screen.

in Step S28, the projection image is tentatively displayed as a preview image using preview image data obtained in Step S26 through processes including provision of shading and correction of colors.

The tentative display of the preview image may be implemented by projecting the preview image directly onto the screen with a digital projector using such preview image data or may be implemented by displaying the preview image directly on a monitor using processed preview image data.

The preview image digitally projected onto the screen or the preview image displayed on the monitor is a displayed image with a showing that agrees or substantially agrees with the showing of the projection image projected onto the screen.

While the conversion of the image data of the projection image using the preview LUT 30a precedes the provision of shading in the illustrated example, the present invention is not limited this way, and the order may be reversed.

The shading measuring method and the method of tentatively displaying the projection image are composed basically as described above.

While, in the above embodiment, the shading of the projection light emitted by the projector 20 that projects the projection image of the screening film onto the screen is considered, the invention is not limited this way and may be likewise applied to the shading of the projection light emitted from a digital movie projector such as a digital projector that projects a projection image corresponding to the image data of an input image onto the screen. As described earlier, the projection light emitted by the digital projector, like the projection light emitted by the projector 20, has a shading such that the amount of the projection light is smaller in the periphery than in the central region of the screen onto which the projection light is projected.

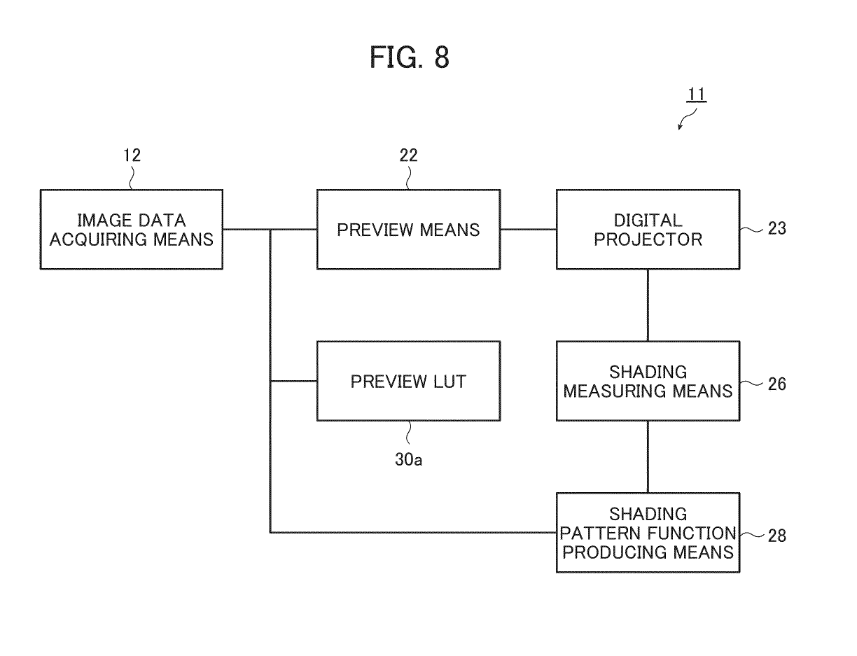

FIG. 8 is a block diagram illustrating an example of a configuration of a movie system adapted to implement the method of tentative display of the projection image according to the invention.

A movie system 11 illustrated therein comprises the image data acquiring means 12, the preview means 22, a digital projector 23, the shading measuring means 26, the shading pattern function producing means 28, and a preview LUT 30a. In the figure, the same components in FIGS. 1 and 2 are assigned identical alphanumeric characters.

The flow of the processes of the method of tentatively displaying the projection image is described below with reference to a case in which the shading of the projection light emitted by the digital projector 23 is corrected.

For example, the measuring position pattern image comprising measuring points in regions thereof including the central region and the periphery as shown in FIG. 7A is projected by the digital projector 23 onto the screen 58 over the whole surface thereof.

Next, the shading pattern of the projection light emitted by the digital projector 23 is measured by the measuring means 26, and the measured shading pattern of the projection light emitted by the digital projector 23 undergoes function approximation by the function producing means 28, thereby producing the shading pattern function of the projection light emitted by the digital projector 23.

The measuring means 26 may measure the shading pattern of the projection light emitted by the digital projector 23, and the function producing means 28 may produce the shading pattern function using the same methods as used for the projection light of the projector 20.

Subsequently, the image data of the input image acquired by the acquiring means 12 are sent via the preview LUT 30a to the preview means 22 and converted to color-corrected image data of the preview image as described earlier.

In the preview means 22, the respective image data of the pixels of the preview image are multiplied by respective coefficient values F(PX,PY) obtained according to the pixel positions using the shading pattern function of the projection light emitted by the digital projector 23 produced by the function producing means 28 to obtain color-corrected preview image data provided with the shading of the projection light emitted by the digital projector 23.

Subsequently, the shading-provided, color-corrected and otherwise processed preview image data thus obtained are used to tentatively display the projection image directly on the screen as preview image using a monitor or a digital projector (another digital projector than the digital movie projector 23).

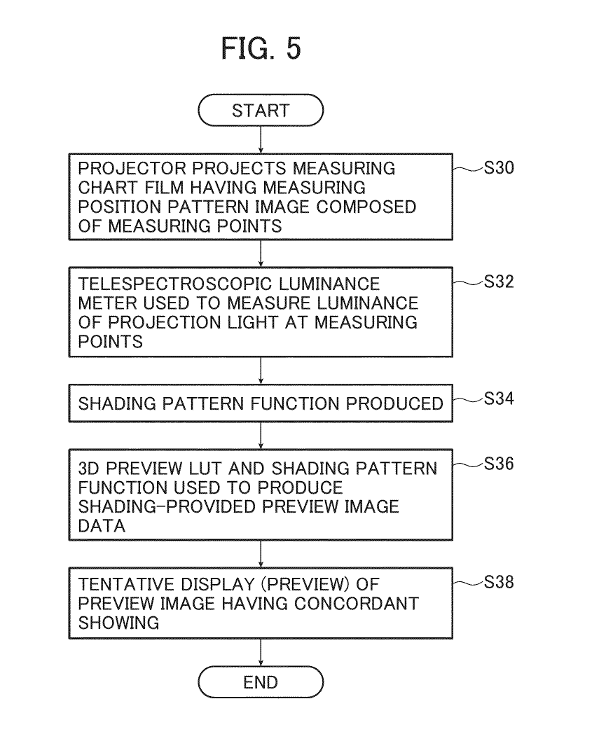

This makes it possible to verify on a monitor or the digital projector the input image, acquired by the acquiring means 12, with the colors and the shading with which the input image will be presented on a screen by the digital movie projector 23 before an actual projection by the digital movie projector 23. The method of tentatively displaying the projection image of the invention is described below with reference to FIG. 5.

First, in Step S30, the projector 20 projects the measuring chart film, as illustrated in FIG. 7A, having the measuring position pattern image containing measuring points in regions including the central region and the periphery onto the screen 58 over the whole surface thereof.

Next, in Step S32, a luminance meter such as a telespectroscopic luminance meter is used to carry out spectral measurement of the amount of light (e.g., luminance) at measuring points in regions including the central region and the periphery of the screen onto which the measuring chart film is projected with the projection light emitted by the projector 20 and acquire the shading pattern of the projection light of the projector 20. The shading may be measured, and the shading pattern acquired, in the same manner as in Step S20 in FIG. 2 as described earlier.

Next, in Step S34, the shading pattern function is produced through function approximation of the shading pattern of the projection light of the projector 20 measured in Step S32. The shading pattern function may be produced in the same manner as in Step S22 in FIG. 2 as described earlier.

Subsequently, in Step S36, the preview LUT30a and the shading pattern function produced in Step S34 are used to produce preview image data having undergone such processes as provision of shading and correction of colors from the edited and/or otherwise processed image data. The processed preview image data may be produced in the same manner as in Step S24 and Step S26 in FIG. 2 as described earlier.

Finally, in Step S38, the processed preview image data produced in Step S36 are used to display the preview image directly on the screen by digital projection or display the preview image on the monitor to tentatively display the projection image. The tentative display of the projection image as preview image may also be implemented in the same manner as in Step S28 in FIG. 2 as described earlier.

The preview image digitally projected onto the screen or the preview image displayed on the monitor is a displayed image which has a showing that agrees or substantially agrees with the showing of the projection image projected onto the screen.

The method of tentatively displaying the projection image according to the invention is composed basically as described above.

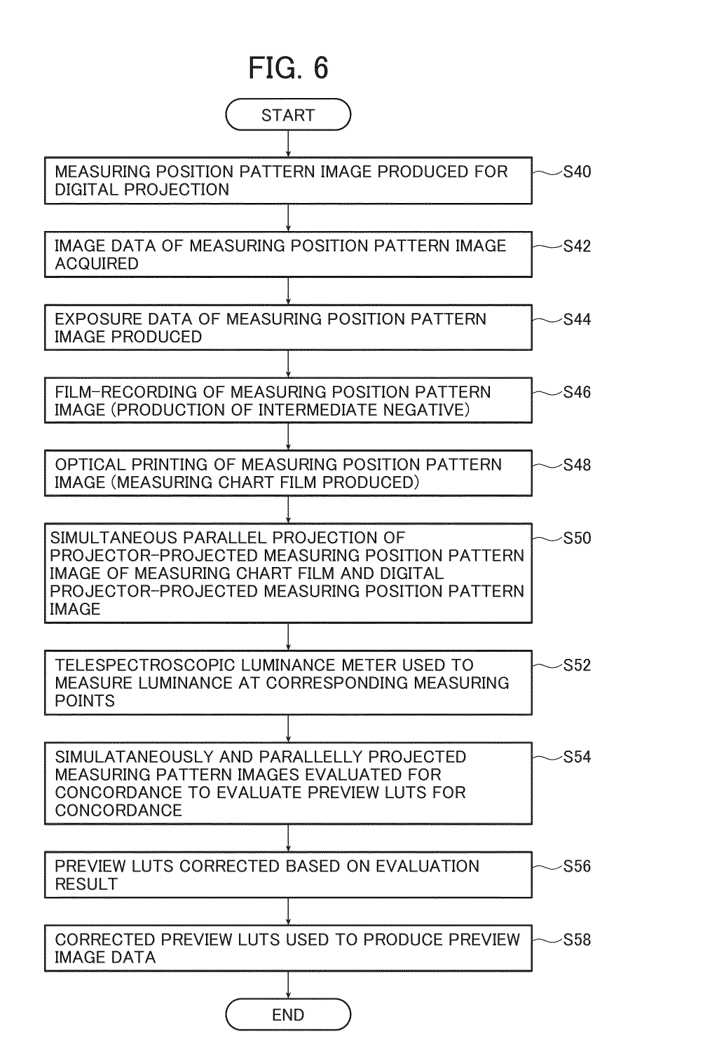

Next, the methods of evaluating, correcting, and using the preview LUT used in the method of tentatively displaying the projection image according to the invention are described with reference to FIG. 6.

First, in Step S40, the measuring position pattern image containing measuring points in regions including the central region and the periphery is previously produced as the projection image in order to evaluate the preview LUT in the method of tentatively displaying the projection image according to the invention. It is preferable to previously produce, for example, the measuring position pattern image for digital projection by the preview means 22.

Next, in Step S42, image data of the measuring position pattern image for digital projection is acquired. In this stage, it is preferable to produce image data of the preview image of the measuring position pattern image from the image data of the measuring position pattern image using the preview LUT.

Subsequently, exposure data of the measuring position pattern image for projection used to expose the image data of the measuring position pattern image to a negative movie film using the color-correction LUT is produced in Step S44.

Next, in Step S46, the exposure data of the measuring position pattern image for projection are used to expose and develop the measuring position pattern image for projection onto a negative movie film with an optical image exposure device to implement film recording, thereby producing an intermediate negative film.

In Step S48, the intermediate negative film is exposed and developed onto a positive movie film to implement optical printing and produce a measuring chart film for screening in which the measuring position pattern image is printed as a projection image.

The exposure data of the measuring position pattern image for projection may be produced and exposed, and the intermediate negative film may be produced, in the same manner as in Step S14 shown in FIG. 2 as described earlier, and the measuring chart film for screening may be produced in the same manner as in Step S16 in FIG. 2 as described earlier.

Next, in Step S50, the measuring position pattern image is tentatively displayed using the image data of the preview image, and the measuring chart film for screening produced in Step S48 is projected onto the screen with a projector. The measuring position pattern image as preview image projected by digital projection and the measuring position pattern image of the measuring chart film for screening are preferably displayed by simultaneous parallel projection, and more preferably, by simultaneous parallel projection whereby, as illustrated in FIG. 7B, both images are projected in the respective half regions of the screen 58.

Subsequently, in Step S52, the respective amounts of light (luminances), measured at the measuring points, of the preview image of the measuring position pattern image tentatively displayed by projection, or preferably, by simultaneous parallel projection in Step S50 and the respective amounts of light (luminance), measured at the measuring points, of the measuring position pattern image on the screen presented by the projection of the measuring chart film onto the screen by the projector 20 are measured with a luminance meter such as telespectroscopic luminance meter.

The respective amounts of light (luminances) at the measuring points need to be measured with the measuring positions presented by digital projection and the measuring positions of the measuring chart film for screening presented on the screen in accurate alignment, and reproducibility of the measuring positions presented on the screen by both projections needs to be secured. The illustrated example is preferable because the measuring position pattern image projected by digital projection is previously obtained as measuring chart and recorded on a film to produce a screening film.

The measuring chart film for screening used for film projection is preferably a film in which a positioning pattern indicating the measuring points repeatedly alternates with a solid region (film base).

Next, in Step S54, the degree of concordance in the amount of measured light (luminance) at corresponding measuring points between the measuring position pattern images projected by simultaneous parallel projection in Step S52, i.e., the degree of concordance between the preview image and the measuring position pattern image of the measuring chart film at the corresponding measuring points, is evaluated.

Next, in Step S56, the preview LUT is corrected based on the result of evaluation obtained in Step S54.

Finally, in Step S58, the preview LUT corrected in Step S56 is used to produce image data of the preview image for tentatively displaying the projection image from the image data of the projection image.

Use of the thus corrected preview LUT makes it possible to achieve a high degree of concordance in showing between the preview image and the film-projected projection image.

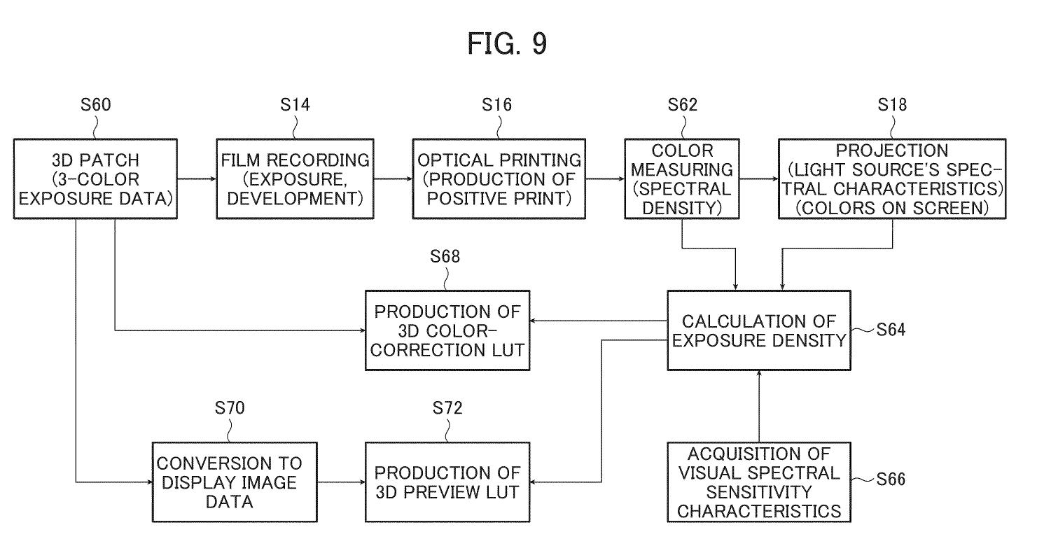

Next, the method of producing a three-dimensional LUT such as a color correction LUT and a preview LUT used in the invention is described with reference to FIG. 9.

First, the method of producing the color correction LUT is described.

An image (Step S60) in which three-dimensional color patches (three-color exposure data) produced with varied exposure data (control values) and neutral gray for variation correction are arranged is exposed and developed (Step S14) onto a negative film for filming, a digital recording film, or an intermediate film with an optical exposure device using laser light scan used by the film recorder 16 to produce a positive print (Step S16) with the optical printer 18 and perform color measurement (Step S62).

In this example, the color measurement is performed by measuring the spectral density at 5-nm intervals in a range of 380 nm to 780 nm using a spectral density meter meeting the conditions described in JAS 28722 “Methods of color measurement: reflecting and transmitting objects.” A status-M density is obtained by calculation.

The produced positive print is projected by the projector 20 (Step S18) to calculate the colors presented on the screen. That is, in Step S66, human visual spectral sensitivity characteristics are acquired previously and, in Step S64, the exposure density is calculated from the spectral density obtained by measuring the positive print for projection produced by the optical printer 18 in Step S62 with the spectral density meter as described above, the spectral characteristics of the light source of the projector 20 at the time of projection in Step S18, and the human visual spectral sensitivity characteristics acquired in Step S66.

Next, in Step S68, the color correction LUT is produced between the exposure density calculated in Step S64 and the exposure data in the film recorder 16 produced in Step S60.

Next, the method of producing the preview LUT is described.

First, in Step S70, the exposure data in the film recorder 16 produced in Step S60 are converted to image data for display that can be used by the preview means 22.

Next, in Step S72, a preview LUT is produced between the exposure density calculated in Step S64 and the image data for display obtained by conversion in Step S70.

In the example illustrated in FIG. 9, an LUT used for, for example, color correction may be produced in addition to said color correction LUT and preview LUT.

For example, an LUT may be produced between the exposure data produced in Step S60 and the status-M density (Step S62) described above.

Now, the method of tentatively displaying the projection image of the invention will be described with reference to examples.

FIGS. 10A, 10B, and 10C are schematic diagrams respectively representing a projection image, a projector shading pattern image, and a shading simulation image obtained by providing the projection image with a shading.

The projection image shown in FIG. 10A is presented by projecting the screening film onto the screen and is a projection image having colors adjusted so as to agree with the colors of the preview image and represented by pixel values (image data) I(PX,PY) of pixels located in position (PX,PY).

On the other hand, the shading pattern image shown in FIG. 10B is the shading pattern image by the projection light from the light source of the projector, i.e., from the light source, and represented by the function F(PX,PY) expressed by the above equation (1), where the coefficients a to f are given in Table 1. It can be said that the function F(PX,PY) is a coefficient from 0.0 to 1.0 and represents a shading pattern luminance in position (PX,PY).

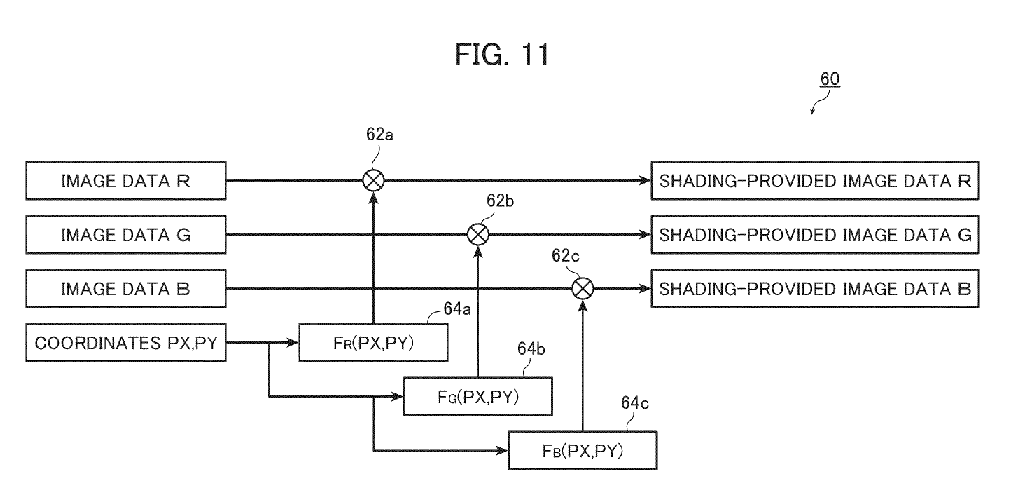

Next, FIG. 11 is a conceptual diagram illustrating an example of a configuration of a processor adapted to provide image data with a shading pattern.

A processor 60 therein illustrated is provided inside, for example, the preview means 22 and comprises three multipliers 62a, 62b, and 62c respectively corresponding to three colors red (R), green (G), and blue (B) and function computing units 64a, 64b, and 64c.

The respective image values I(PX,PY) of the pixels of the projection image are composed of pixel values (image data) R, G, and B corresponding to three colors red, green, and blue. Likewise, the function F(PX,PY) represented by the equation (1) also comprises functions F_{R}(PX,PY), F_{G}(PX,PY), and F_{B}(PX,PY) corresponding to three colors red, green, and blue.

According to the invention, the projection image provided with a shading shown in FIG. 10C, i.e., a shading simulation image I(PX,PY)×F(PX,PY) can be produced by multiplying the projection image I(PX,PY) illustrated in FIG. 10A by the shading pattern function F(PX,PY) illustrated in FIG. 10B, with correspondence between the pixel positions in the projection image and the values in the shading pattern function in the corresponding pixel positions.

That is, the processor 11 illustrated in FIG. 11 is capable of calculating the values of functions F_{R}(PX,PY), F_{G}(PX,PY), and F_{B}(PX,PY) with the function computing units 64a, 64b, and 64c based on the equation (1) using the coordinates PX, PY. The multipliers 62a, 62b, and 62c multiply the pixel value R by the value of the function F_{R}(PX,PY), the pixel value G by the value of the function F_{G}(PX,PY), and the pixel value B by the value of the function F_{B}(PX,PY) to calculate the pixel values R, G, and B as provided with shadings.

Thus, tentative display of the shading simulation image I(PX,PY)×F(PX,PY) shown in FIG. 10C as preview image allows display of a preview image that agrees or substantially agrees in showing with the projection image projected by the projector onto the screen.

While the preview image is provided with a shading so as to agree in showing with the projection image projected onto the screen in the above example, the present invention is not limited thereto; the projection image of the screening film to be projected onto the screen may have its shading removed, the screening film from which the shading is previously removed may be produced, the screening film from which the shading is previously removed may be used, or the screening film from which the shading is previously removed may be projected onto the screen.

For example, the invention may also be applied to production of a screening film having a projection image with a showing that agrees or substantially agrees with, or is similar, to the showing of the projection image verified with the preview image of the projection image that is tentatively displayed before the screening film is projected onto the screen by a movie system with a projector.

According to that method of producing a screening film, the shading pattern of a projector used to project the projection image of the screening film onto the screen is previously measured.

Next, the input image is edited to produce image data of the projection image.

Then, the color-correction LUT that is used to obtain the image data of the preview image from the image data of the projection image is produced so that the colors of the projection image are reproduced in the tentatively displayed projection image.

Next, using the color-correction LUT for obtaining the projection image that has colors that agree with, approximate, or are similar to the colors of the projection image previewed using the image data of the preview image produced based on the image data of the produced projection image and which is so presented as when the screening film is projected onto the screen, the exposure data of the projection image for producing the screening film from the image data of the projection image is produced while the exposure data of the projection image is provided with the projector shading pattern to produce exposure data of the projection image provided with the shading.

Thereafter, the exposure data of the projection image provided with the shading is used to expose and develop the projection image onto the negative movie film with an optical image exposure device, thereby producing the intermediate film.

Finally, the intermediate film is exposed and developed onto the positive movie film to produce the screening film that has the projector shading corrected and has printed thereon the projection image having, when projected onto the screen, the same showing as the preview image.

Thus, it is made possible to produce a screening film that has the shading previously removed therefrom and whereby the projection image and the preview image can be adapted to have a concordant showing when the screening film is projected onto the screen.

By projecting the thus produced screening film with a projector onto the screen, a projection image having the same or substantially the same showing as the preview image can be projected onto the screen.

The thus produced screening film is a screening film having the projector shading removed therefrom or corrected and having the same or substantially the same showing as the preview image when projected onto the screen.

The present invention may also be composed by, for example, a program adapted to cause a computer to execute the steps of the method of tentatively displaying the projection image and the screening film production method and a computer readable medium on which the program is recorded.

While the method and device of tentatively displaying the projection image, the screening film, the method and the device for producing the same, the projection image projecting method, the program, and the movie system according to the invention have been described in detail above, the present invention is not limited to the above embodiments, and various modifications and improvements may be made without departing from the spirit and scope of the invention.

We claim:

1. A method of tentatively displaying a projection image for verifying a showing of the projection image when a screening film of a movie system is projected onto a screen before the screening film is projected onto the screen, the method comprising:
measuring a shading pattern of a projector used to project the projection image of the screening film onto the screen,
editing an input image to produce image data of the projection image,
producing image data of a color-correction tentative-display image for tentatively displaying the projection image from image data of the projection image using a lookup table for obtaining a tentative-display image having colors that agree with, approximate, or are similar to colors of the projection image when the screening film produced based on the image data of the produced projection image is projected onto the screen and producing image data of a shading-provided tentative-display image by providing image data of the color-correction tentative-display image with a shading pattern of the projector, and
tentatively displaying the projection image as the tentative-display image based on image data of the shading-provided tentative-display image in order to verify a showing of the projection image to be projected onto the screen using the projector.

2. The method of tentatively displaying a projection image according to claim 1,
wherein the step of measuring the shading pattern comprises irradiating the screen with projection light of the projector and measuring an amount of light at measuring points in regions of the screen including a central region and a periphery to acquire a light amount distribution.

3. The method of tentatively displaying a projection image according to claim 1, wherein the step of measuring the shading pattern comprises projecting a measuring chart including a measuring position pattern image containing measuring points in regions including a central region and a periphery onto the screen with the projector and measuring luminance at the measuring points projected onto the screen with a telespectroscopic luminance meter.

4. The method of tentatively displaying a projection image according to claim 2,
wherein the step of measuring the shading pattern further comprises acquiring a shading pattern function that approximates a relation between the positions of the measuring points and respective amounts of light at the measuring points, and
wherein the step of producing image data of the shading-provided tentative-display image comprises correcting image data of the color-correction tentative-display image using the shading pattern function.

5. The method of tentatively displaying a projection image according to claim 1,
further comprising producing a measuring position pattern image as the projection image containing measuring points in regions of the screen including a central region and a periphery,
producing image data of the tentative-display image of the measuring position pattern image from image data of the measuring position pattern image using the lookup table,
producing a measuring chart film for screening in which the measuring position pattern image is printed as the projection image on a movie film from image data of the measuring position pattern image,
tentatively displaying the measuring position pattern image using image data of the tentative-display image and measuring luminance of the tentatively displayed tentative-display image of the measuring position pattern image at measuring points with a telespectroscopic luminance meter,
screening the measuring chart film onto the screen with the projector and measuring luminance of the measuring position pattern image at the measuring points on the screen with the telespectroscopic luminance meter,
making an evaluation of a degree of concordance between measured luminance of the tentative-display image measured at the measuring points and luminance of the measuring position pattern image of the measuring chart film measured at corresponding measuring points,
correcting the lookup table based on the evaluation, and
producing image data of a tentative-display image for tentatively displaying the projection image from image data of the projection image using the corrected lookup table.

6. The method of tentatively displaying a projection image according to claim 5, wherein tentative display of the tentative-display image of the measuring position pattern image is implemented with a digital projector by direct projection using image data of the measuring position pattern image onto a same screen onto which the measuring position pattern image is projected using the measuring chart film.

7. The method of tentatively displaying a projection image according to claim 6, wherein tentative display of the tentative-display image and screening of the measuring position pattern image using the measuring chart film are implemented in parallel and simultaneously on a same screen.

8. The method of tentatively displaying a projection image according to claim 5, wherein tentative display of the tentative-display image is implemented using image data of the measuring position pattern image on a monitor simultaneously and in parallel with screening of the measuring position pattern image using the measuring chart film.

9. The method of tentatively displaying a projection image according to claim 5, wherein the step of producing the measuring chart film comprises:
producing exposure data of the projection image to be exposed to the movie film using a color-correction lockup table from image data of the measuring position pattern image,
exposing and developing the projection image onto the movie film with an optical image exposure device using the exposure data of the projection image to produce an intermediate film, and
exposing and developing the intermediate film onto the movie film to produce the measuring chart film for screening in which the measuring position pattern image is printed as the projection image.

10. The method of tentatively displaying a projection image according to claim 1, wherein the step of tentatively displaying the projection image comprises projecting the tentative-display image directly onto the screen with a digital projector using image data of the tentative-display image.

11. The method of tentatively displaying a projection image according to claim 1, wherein the step of tentatively displaying the projection image comprises displaying the tentative-display image on a monitor using image data of the tentative-display image.

12. A screening film production method for producing a screening film of a movie system including a projection image whose showing agrees with or is similar to a showing of the projection image verified with a tentative-display image of the projection image that is tentatively displayed before the screening film is projected onto a screen with a projector, the method comprising:
measuring a shading pattern of the projector used to project the projection image of the screening film onto the screen,
editing an input image to produce image data of the projection image,
producing exposure data of a projection image for producing the screening film from image data of the projection image by using a color-correction lookup table for obtaining the projection image when the screening film, having colors that agree with, approximate, or are similar to colors of the projection image tentatively displayed using image data of a tentative-display image produced based on the image data of the produced projection image, is projected onto the screen, and producing exposure data of a shading-provided projection image by providing the exposure data of the projection image with a shading pattern of the projector,
exposing and developing the projection image onto a movie film with the optical image exposure device using the exposure data of the shading-provided projection image to produce an intermediate film, and
exposing and developing the intermediate film onto the movie film to produce a screening film having printed thereon the projection image having the shading of the projector so corrected that the projection image has a same showing as the tentative-display image when the screening film is projected onto the screen by the projector.

13. A projection image projecting method, comprising screening the screening film produced by the screening film production method of claim 12 with the projector onto the screen to project the projection image having a same showing as the tentative-display image onto the screen.

14. A screening film that is projected onto a screen by a projector in a movie system, comprising a projection image having a corrected shading of the projector and having a same showing that agrees with or is similar to a showing of a tentative-display image of the projection image for verifying colors of the projection image produced from an input image by editing before the screening film is projected onto the screen.

15. A method of tentatively displaying a projection image for verifying a showing of the projection image when the projection image is projected onto a screen by a digital movie projector before the projection image is projected onto the screen, the method comprising:
measuring a shading pattern of the projector used to project a projection image corresponding to image data of an input image onto the screen,
producing image data of a color-correction tentative-display image for tentatively displaying the projection image from image data of the input image using a lookup table for obtaining a tentative-display image having colors that agree with, approximate, or are similar to colors of the projection image when the projection image corresponding to the image data of the input image is projected onto the screen and producing image data of a shading-provided tentative-display image by providing image data of the color-correction tentative-display image with a shading pattern of the projector, and
tentatively displaying the projection image as the tentative-display image based on the image data of the shading-provided tentative-display image in order to verify a showing of the projection image to be projected onto the screen using the projector.

16. The method of tentatively displaying a projection image according to claim 15, wherein the step of measuring the shading pattern comprises irradiating the screen with projection light of the projector and measuring an amount of light at measuring points in regions of the screen including a central region and a periphery to acquire a light amount distribution.

17. The method of tentatively displaying a projection image according to claim 15, wherein the step of measuring the shading pattern comprises projecting a measuring chart including a measuring position pattern image containing measuring points in regions including a central region and a periphery onto the screen with the projector and measuring luminance at the measuring points projected onto the screen with a telespectroscopic luminance meter.

18. The method of tentatively displaying a projection image according to claim 16,
wherein the step of measuring the shading pattern further comprises acquiring a shading pattern function that approximates a relation between positions of the measuring points and respective amounts of light at the measuring points, and
wherein the step of producing image data of the shading-provided tentative-display image comprises correcting image data of the color-correction tentative-display image using the shading pattern function.

19. The method of tentatively displaying a projection image according to claim 15, wherein the step of tentatively displaying a projection image comprises projecting the tentative-display image directly onto the screen with a digital projector using image data of the tentative-display image.

20. The method of tentatively displaying a projection image according to claim 15, wherein the step of tentatively displaying a projection image comprises displaying the tentative-display image on a monitor using image data of the tentative-display image.

21. A device for tentatively displaying a projection image for verifying a showing of a projection image when a screening film of a movie system is projected onto a screen before the screening film is projected onto the screen, the device comprising:
a measuring unit adapted to measure a shading pattern of a projector used to project the projection image of the screening film onto the screen,
a producing unit adapted to edit an input image to produce image data of the projection image,
a generating unit adapted to produce image data of a color-correction tentative-display image for tentatively displaying the projection image from image data of the projection image using a lookup table for obtaining a tentative-display image having colors that agree with, approximate, or are similar to colors of the projection image when the screening film produced based on the image data of the produced projection image is projected onto the screen and produce image data of a shading-provided tentative-display image by providing image data of the color-correction tentative-display image with a shading pattern of the projector, and
a display unit adapted to tentatively display the projection image as the tentative-display image based on image data of the shading-provided tentative-display image in order to verify a showing of the projection image to be projected onto the screen using the projector.

22. A screening film producing device for producing a screening film of a movie system including a projection image whose showing agrees with or is similar to a showing of the projection image verified with a tentative-display image of the projection image tentatively displayed before the screening film is projected onto a screen with a projector, the device comprising:
a measuring unit adapted to measure a shading pattern of the projector used to project the projection image of the screening film onto the screen,
a producing unit adapted to edit an input image to produce image data of the projection image,
a generating unit adapted to produce exposure data of a projection image for producing the screening film from image data of the projection image, using a color-correction lockup table for obtaining the projection image when the screening film, having colors that agree with, approximate, or are similar to colors of the projection image tentatively displayed using image data of a tentative-display image produced based on the image data of the produced projection image, is projected onto the screen, and produce exposure data of a shading-provided projection image by providing exposure data of the projection image with a shading pattern of the projector,
a first film producing unit adapted to expose and develop the projection image onto a movie film with the optical image exposure device using exposure data of the shading-provided projection image to produce an intermediate film, and
a second film producing unit adapted to expose and develop the intermediate film onto the movie film to produce a screening film having printed thereon the projection image having the shading of the projector so corrected that the projection image has a same showing as the tentative-display image when the screening film is projected onto the screen by the projector.

23. A device for tentatively displaying a projection image for verifying a showing of the projection image when the projection image is projected onto a screen by a digital movie projector before the projection image is projected onto the screen, the device comprising:
a measuring unit adapted to measure a shading pattern of the projector used to project a projection image corresponding to image data of an input image onto a screen,
a producing unit adapted to produce image data of a color-correction tentative-display image for tentatively displaying the projection image from image data of the input image using a lookup table for obtaining a tentative-display image having colors that agree with, approximate, or are similar to colors of the projection image when a projection image corresponding to the image data of the input image is projected onto the screen and produce image data of a shading-provided tentative-display image by providing image data of the color-correction tentative-display image with a shading pattern of the projector, and
a display unit adapted to tentatively display the projection image as the tentative-display image based on image data of the shading-provided tentative-display image in order to verify a showing of the projection image to be projected onto the screen using the projector.

24. A computer readable recording medium having recorded thereon a program adapted to cause a computer to execute steps for tentatively displaying a projection image for verifying a showing of the projection image when a screening film of a movie system is projected onto a screen before the screening film is projected onto the screen, wherein the program comprises:
a step of acquiring a shading pattern of a projector used to project the projection image of the screening film measured by a measuring unit onto the screen,
a step of editing an input image to produce image data of the projection image,
a step of producing image data of a color-correction tentative-display image for tentatively displaying the projection image from image data of the projection image using a lookup table for obtaining a tentative-display image having colors that agree with, approximate, or are similar to colors of the projection image when the screening film produced based on the image data of the produced projection image is projected onto the screen and producing image data of a shading-provided tentative-display image by providing image data of the color-correction tentative-display image with a shading pattern of the projector, and
a step of causing a display unit to tentatively display the projection image as the tentative-display image based on image data of the shading-provided tentative-display image in order to verify a showing of the projection image to be projected onto the screen using the projector.

25. A computer readable recording medium having recorded thereon a program adapted to cause a computer to execute steps of producing a screening film of a movie system including a projection image whose showing agrees with or is similar to a showing of the projection image verified with a tentative-display image of the projection image tentatively displayed before the screening film is projected onto a screen with a projector, wherein the program comprises:
a step of acquiring a shading pattern of the projector used to project the projection image of the screening film measured by a measuring unit onto the screen,
a step of editing an input image to produce image data of the projection image,
a step of generating exposure data of a projection image for producing the screening film from image data of the projection image using a color-correction lookup table for obtaining the projection image when the screening film, having colors that agree with, approximate, or are similar to colors of the projection image tentatively displayed using image data of a tentative-display image produced based on the image data of the produced projection image, is projected onto the screen, and produce exposure data of a shading-provided projection image by providing the exposure data of the projection image with a shading pattern of the projector,
a step of causing a first film producing unit to expose and develop the projection image onto a movie film with the optical image exposure device using the exposure data of the shading-provided projection image to produce an intermediate film, and
a step of causing a second film producing unit to expose and develop the intermediate film onto the movie film to produce a screening film having printed thereon the projection image having the shading of the projector so corrected that the projection image has a same showing as the tentative-display image when the screening film is projected onto the screen by the projector.

26. A computer readable recording medium having recorded thereon a program adapted to cause a computer to execute steps for tentatively displaying a projection image for verifying a showing of the projection image when the projection image is projected onto a screen by a digital movie projector before the projection image is projected onto the screen, wherein the program comprises:
a step of acquiring a shading pattern of the projector used to project a projection image corresponding to image data of an input image measured by a measuring unit onto the screen,
a step of producing image data of a color-correction tentative-display image for tentatively displaying the projection image from image data of the input image using a lockup table for obtaining a tentative-display image having colors that agree with, approximate, or are similar to colors of the projection image when a projection image corresponding to the image data of the input image is projected onto the screen and produce image data of a shading-provided tentative-display image by providing image data of the color-correction tentative-display image with a shading pattern of the projector, and
a step of causing a display unit to tentatively display the projection image as the tentative-display image based on the image data of the shading-provided tentative-display image in order to verify a showing of the projection image to be projected onto the screen using the projector.

27. A movie system, comprising:
a screen;
a projector adapted to project a projection image of a screening film onto the screen; and
a device for tentatively displaying a projection image described in claim 21.

28. A movie system, comprising:
a screen;
a projector adapted to project a projection image of a screening film onto the screen; and
a screening film producing device described in claim 22.

29. A movie system, comprising:
a screen;
a projector adapted to project a projection image of a screening film onto the screen; and
a device for tentatively displaying a projection image described in claim 23.
